(19) United States
(12) Patent Application Publication
(10) Pub. No.: US 2004/0097677 A1
(43) Pub. Date: May 20, 2004

(54) Partially fluorinated amorphous copolymer which makes it possible to manufacture light-conducting materials

(75) Inventors: Bernard Boutevin, Montpellier (FR); Alain Rousseau, Montpellier (FR); Jean-Marc Sage, Oullins (FR)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: Atofina

(21) Appl. No.: 10/299,062

(22) Filed: Nov. 19, 2002

(30) Foreign Application Priority Data
Nov. 19, 2002 (FR) 01.14939

(51) Int. Cl. C08F 114/18

(52) U.S. Cl. 526/249; 526/250; 526/266

(57) ABSTRACT

The invention comprises a vinylene carbonate (VCA) copolymer having as comonomer chlorotrifluoroethylene (CTFE) or tetrafluoroethylene (TFE). This copolymer is transparent, making possible the preparation of objects acting as guide or conductor for light with wavelengths of visible or near infrared type. Furthermore, it exhibits a glass transition temperature of greater than 60° C. which is appropriate for the preparation of optical fibers.

### BACKGROUND OF THE INVENTION

This application claims benefit of priority of French Application No. 01.14939, filed Nov. 19, 2001, which is incorporated herein by reference in its entirety.

(i) Field of the Invention

The subject-matter of the present invention is a vinylene carbonate (VCA) copolymer having as comonomer chlorotrifluoroethylene (CTFE) or tetrafluoroethylene (TFE). This copolymer is transparent, making possible the preparation of objects acting as a guide or conductor for light with wavelengths of visible or near infrared type. Furthermore, it exhibits a glass transition temperature of greater than 60° C. which is appropriate for the preparation of optical fibers.

(ii) Description of the Related Art

It is of great interest to design a polymer material having the properties necessary for preparing optical fibers. Reference may be made, to this end, to the article “Polymeric Materials for Devices in Optical Fiber Systems” by Anthony R. Blythe and John R. Vinson (Polymers for Advanced Technologies, Vol 11, pages 601-611, 2000).

Perfluorinated amorphous polymers, derived from perfluorinated cyclic monomers, exhibiting glass transition temperatures of greater than 100° C. are already known in the manufacture of optical fibers. However, the synthesis of these perfluorinated cyclic monomers is difficult and lengthy (several synthetic stages). It requires the use of dangerous fluorinating agents, which limits their accessibility and leads to very high cost prices for the polymer (see “TEFLON® AF Amorphous Fluoropolymers,” Paul R. Resnick and Warren H. Buck, Modern Fluoropolymers, pages 397-398, edited by John Scheires, 1997, John Wiley & Sons Ltd).

Moreover, these fluorinated polymers are difficult to dissolve in the usual solvents, which implies the use of fluorinated solvents, with the disadvantages which that represents.

Polymers with the repeat entity —(CF₂—CFX)— in which X=F, Cl or Br have a glass transition temperature (Tg), the temperature above which limited movements of the polymer chains are possible, which is not very high. Their Tg is close to ambient temperature, which does not make it possible to ensure complete stability of the optical properties under the thermal or climatic conditions of use of the materials.

A random copolymer resulting from the copolymerization of chlorotrifluoroethylene (CTFE) and vinylene carbonate (VCA) with a molecular mass (Mn) of 2,000 is also known in the literature (M. Krebs and C. Schneider, Adv. Chem. Ser., Vol. 142, pages 92-98, 1975), which copolymer exists in the form of a white solid incompatible with an optical application.

The fluorinated materials developed to date involve monomers or oligomers which are difficult to access, either because of the number of stages necessary for their synthesis or because of the danger generated by the use of fluorinating agents or because of their cost. Furthermore, these fluorinated materials exhibit an inadequate thermomechanical behavior.

### SUMMARY OF THE INVENTION

It is therefore seen that no fluorinated or partially fluorinated material developed to date is fully satisfactory.

A colorless and transparent copolymer, which is soluble in the usual solvents (acetone, THF, ethyl acetate, among others), which has a glass transition temperature of greater than 60° C. and which is obtained from chlorotrifluoroethylene or tetrafluoroethylene, industrial fluorinated monomers, and vinylene carbonate, a readily accessible nonhalogenated monomer, has been found by the Applicant Company. This copolymer exhibits the optical and thermomechanical properties required for applications such as:

the manufacture of light-conducting articles, for example optical fibers;

the manufacture of coatings or films, for example antireflection coatings or films; or

the manufacture of photomasks.

The subject-matter of the invention is a copolymer comprising at least two repeat units P1 and P2 of following general formulae, i and j corresponding to a repeat number of units:

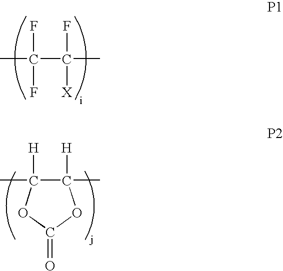

the copolymer being transparent, of amorphous nature its molecular mass (Mn) being comprised between 5.10³ and 10⁵ and having a content of P2 units of between substantially 30 and 70 mol % for X=F or Cl in P1.

According to one embodiment of the copolymer, its glass transition temperature (Tg) is between 60° C. and 160° C.

The invention also relates to a manufactured article made of a material comprising a copolymer as described above.

The invention relates to an optical fiber based on copolymer as described above.

A subject-matter of the invention is the use of the copolymer as described above for manufacturing coatings or films.

The subject-matter of the invention includes the use of the copolymer as described above for manufacturing light-conducting articles.

### DETAILED DESCRIPTION OF THE PREFERRED EMBODIMENTS

The copolymer according to the invention comprises the repeat units P1 and P2 represented below.

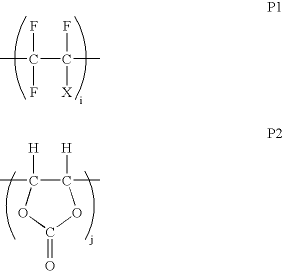

P1 results from the polymerization of i monomers M1 and P2 results from the polymerization of j monomers M2.

The monomer M1 is a fluorinated monomer represented by the following general formula: CF₂=CFX, in which X is either:

a fluorine atom, in which case M1 is tetrafluoroethylene;

a chlorine atom, in which case M1 is chlorotrifluoroethylene.

The repeat entities P1 can result from a mixture of monomers of formula M1.

The comonomer M2, which gives rise to the repeat entities P2, is vinylene carbonate with the following formula:

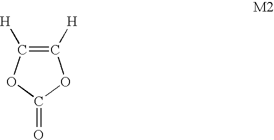

Use may be made, as a process which makes it possible to obtain the polymer, of any polymerization process known to a person skilled in the art using a solvent medium, in suspension in water or in emulsion, for example. It will generally be preferable to operate in a solvent medium, in order to control the exothermicity of the polymerization and to promote intimate mixing of the various monomers.

Mention may be made, among solvents commonly used, of ethyl, methyl or butyl acetate or chlorofluorinated solvents, such as F141b® (CFCl₂—CH₃) or F113® (CF₂Cl—CFCl₂).

Use may be made, as polymerization initiator, of free radical generators, such as peroxide, hydroperoxide or percarbonate derivatives or azo compounds, such as azoisobutyronitrile (AIBN). Use may also be made, in the cases of processes carried out in an aqueous medium, of inorganic free radical generators, such as persulphates or “redox” combinations.

The polymerization temperature is generally dictated by the rate of decomposition of the initiator system chosen and is generally situated between 0 and 200° C., preferably between 40 and 120° C.

The pressure is generally between atmospheric pressure and a pressure of 50 bars, more particularly between 2 bars and 20 bars.

In order to exert better control over the composition of the polymer, it is also possible to introduce, in all or in part, the monomers and the polymerization initiator continuously or portionwise during the polymerization.

The copolymer according to the invention has a glass transition temperature (Tg) lying between 60 and 160° C., preferably between 80 and 140° C. This glass transition temperature is mainly related to the content of P2 units present in the copolymer. The transparency of the polymer obtained also depends on the content of P2 units.

The content of P2 units, which repeat unit results from the polymerization of monomers M2, can vary in the copolymer as a function of the nature of X of P1. For X=F or Cl in P1, the content of P2 units in the copolymer is between substantially 30 and 70 mol %.

Without prejudicing the invention, it is also possible to introduce a third monomer during the polymerization, provided that its content remains less than 15 mol % in the copolymer formed.

The polymer according to the invention has a number-average molecular mass (Mn) of between 500 and 10⁶ and preferably between 10⁴ and 10⁵.

The invention will now be illustrated by presenting examples of the implementation of the invention.

The reactors, initiators and solvents used are abbreviated:

| | |
|---|---|
| CTFE: | chlorotrifluoroethylene CF₂═CFCl |
| TFE: | tetrafluoroethylene CF₂═CF₂ |
| VCA: | vinylene carbonate |
| TBPP: | tert-butyl perpivalate, at 75% by mass in isododecane |
| F141b®: | 1,1,1-dichlorofluoroethane |

The Mn (number-average molecular mass) values are determined by SEC (steric exclusion chromatography) analysis. A device from Spectra Physic, “Winner Station,” is used. Detection is carried out by refractive index. The column is a 5 micron mixed C PL gel column from Polymer Laboratory and the solvent used is THF with a flow rate of 0.8 ml/min. The number-average molecular masses (Mn) are expressed in g.mol⁻¹ in comparison with a polystyrene standard.

The Tg (glass transition temperature) values are determined by differential scanning calorimetry (DSC). A first temperature rise is carried out at 20° C. per minute, followed by cooling and then a second temperature rise, during which the Tg (glass transition temperature) values or the Tm (melting temperature) values are recorded. The temperature range is from 50° C. to 200° C. if the Tg is greater than 60° C.

The chlorine levels are determined conventionally by ashing in a Parr bomb with Na₂O₂ and then quantitatively determining the chlorides by argentometry.

### EXAMPLE 1

[M1/M2: CTFE/VCA]

The polymerization is carried out in a 160 ml stainless steel reactor purged two to three times with 5 bars of nitrogen. 50 ml of an F141b® solution comprising 0.6 ml (i.e. 2.25 mmol) of TBPP initiator and 8.53 g (i.e. 99 mmol) of VCA are introduced by suction into the reactor under vacuum (pressure of approximately 100 mbars). 11 g (i.e. 94.5 mmol) of CTFE are subsequently introduced. The reaction medium is heated at 80° C. for 2 h 30 with stirring with an initial pressure of approximately 10 bars. After the reaction, the contents of the autoclave are partially evaporated, precipitated with heptane and then dried under vacuum.

16.2 g of copolymer are thus obtained. The copolymer is soluble in the usual solvents (acetone, THF). The analyses carried out on the copolymer obtained in Example 1 indicate a molar ratio P1/P2 of 47/53, an Mn of 7,400 and a Tg of 120° C. By dissolving in ethyl acetate and evaporating, a transparent colorless film is obtained.

### EXAMPLE 2

[M1/M2: CTFE/VCA]

The polymerization is carried out in the same way as in Example 1 with the same reactants and the same proportions. The solvent ethyl acetate is employed in place of F141b®. At the end of the reaction, a solution of polymer in ethyl acetate is obtained. The solvent is evaporated until a volume of approximately 20 ml is obtained and then the reaction product is precipitated with n-heptane. The precipitated polymer is filtered off and then dried under vacuum at 60° C. 10 g of a transparent colorless copolymer are obtained. The copolymer is soluble in THF or acetone. The molar ratio P1/P2 is 49/51 and the Tg is 106° C.

1 g of this copolymer is withdrawn and is dissolved in 3 ml of ethyl acetate. The solution thus obtained is completely clear. This solution is deposited in a flat crystallizing dish with a diameter of 7 cm and the solvent is allowed to evaporate for 3 days at ambient temperature and ambient atmosphere. The film thus obtained is completely transparent and clear.

Comparative Examples 3, 5, 6 and 7 and an Example 4 are carried out by proceeding in the same way as in Example 2 with the amounts of reactants CTFE and VCA shown in Table 1 below.

The Examples and Comparative Examples in Table 1 involve, at the beginning of the reaction, x mmol of CTFE and y mmol of VCA, such that: Comparative Example 5: x=181 and y=10.5; Comparative Example 3: x=186 and y=40; Example 2: x=95 and y=98; Example 1: x=94.5 and y=99; Example 4: x=86 and y=174; Comparative Example 6: x=43 and y=174; Comparative Example 7: x=0 and y=180.

The molar ratios P1/P2, the yield of polymer obtained in mol %, the appearance of the polymer solution obtained on conclusion of the reaction for the polymerization of M1 and M2, and the appearance of the film of the polymer are reported in Table 1 for Examples 1, 2 and 4 and Comparative Examples 3 and 5 to 7.

TABLE 1

| | | | | Observations |
|---|---|---|---|---|
| | Molar ratio | | Appearance of | relating to |
| | P1/P2 | | the solution | the film |
| | (1) | Yield in % | (2) | obtained |
| Comparative | 95/5 | 5% | clear | Opalescent |
| Example 5 | | | | |
| Comparative | 85/15 | 28% | clear | Transparent |
| Example 3 | | | | Tg <50°C. |
| Example 2 | 49/51 | 51% | clear | Transparent |
| | | | | Tg 106° C. |
| Example 1 | 47/53 | # | clear | Transparent |
| | | | | Tg 120° C. |
| Example 4 | 33/67 | 49% | clear | Transparent |
| Comparative | 20/80 | 60% | Significant | Transparent + |
| Example 6 | | | presence of | opaque |
| | | | insoluble | insoluble |
| | | | materials | materials |
| Comparative | 0/100 | 70% | Presence of | Opaque |
| Example 7 | | | insoluble | insoluble |
| | | | materials | materials |

(1) P1 having for monomer M1 = CTFE; P2 having for monomer M2 = VCA.
(2) Solution: 1 g of polymer in 3 ml of ethyl acetate.

It is observed that, for Examples 1, 2 and 4, comprising molar ratios P1/P2 of between substantially 70/30 and 30/70 with M1=CTFE and M2=VCA, the copolymer solution obtained is clear and the copolymer film obtained after evaporation of the solvent from the solution is a transparent solid. It is found that, in the case of Comparative Examples 3, 5, 6 and 7, comprising molar ratios P1/P2 situated outside the abovementioned range, the copolymer film is a nontransparent solid.

### EXAMPLE 8

[M1/M2: TFE/VCA]

The polymerization is carried out in the same way as in Example 2 but with 7 g (i.e. 81.3 mmol) of VCA and 11 g (i.e. 110 mmol) of TFE in place of the CTFE. 14.6 g of copolymer are obtained. The copolymer is very soluble in acetone or THF. By evaporation of the acetone, a transparent colorless film is obtained. ¹⁹F NMR analysis indicates a molar ratio P1/P2 of 70/30. The Tg of the copolymer is 82° C. (DSC analysis).

Other tests were also carried out with M1=TFE and M2=VCA. It was observed that, for molar ratios P1/P2 of between substantially 70/30 and 30/70, substantially transparent copolymer films were obtained.

What is claimed is:

1. A copolymer comprising at least two repeat units P1 and P2 of following general formulae, i and j corresponding to a repeat number of units: 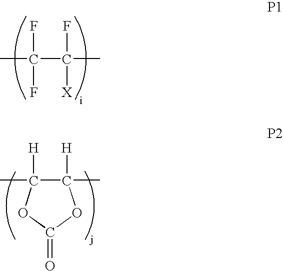
said copolymer being transparent, of amorphous nature, of molecular mass (Mn) comprised between 5.10³ and 10⁵ and having a content of P2 units of between substantially 30 and 70 mol % for X=F or Cl in P1.

2. Copolymer according to claim 1, having a glass transition temperature (Tg) of between 60° C. and 160° C.

3. A manufactured article made of a material comprising a copolymer according to claim 1.

4. An optical fiber comprising the copolymer according to claim 1.

5. A method for manufacturing coatings or films comprising applying copolymer of claim 1 onto a substrate.

6. A method for manufacturing a light-conducting article comprising forming a light conducting article from the copolymer of claim 1.
